(19) United States
(12) Patent Application Publication
(10) Pub. No.: US 2019/0314845 A1
(43) Pub. Date: Oct. 17, 2019

(54) DEVICE AND METHOD FOR MASKING SECURING BOREHOLES IN RIMS DURING THE COATING THEREOF

(71) Applicant: EISENMANN SE, Böblingen (DE)

(72) Inventors: Jürgen Röckle, Magstadt (DE); Herbert Schulze, Aidlingen (DE)

(21) Appl. No.: 16/317,076

(22) PCT Filed: Jun. 30, 2017
(86) PCT No.: PCT/EP2017/066257

§ 371 Date: Jan. 11, 2019

(30) Foreign Application Priority Data
Jul. 12, 2016 (DE) 10 2016 112 797.3

(51) Int. Cl. B05B 12/30; B05B 12/26; B23P 19/00

(52) U.S. Cl. CPC B05B 12/30; B05B 12/26; B60B 30/08; B23P 2700/50; B23P 19/004

(57) ABSTRACT

A device for masking securing boreholes in rims with masking elements having a storage container for the masking elements, a pressure generation unit, a connection unit connected to the storage container and an at least substantially tubular discharge device, which is secured at one end to the connection unit and which has a discharge opening at the opposite end for discharging the masking elements. The discharge device has a tube wall in which a channel for conducting a fluid is formed, the channel being connected to the pressure generation unit. The tube wall consists at least partially of an elastic material, through which the channel runs or in which a cavity connected to the channel is formed, such that, when the pressure of the fluid is changed, the tube wall deforms and releases the clamping on the masking elements. The connection unit and the discharge device are formed preferably as one piece in a 3D printing method.

### BACKGROUND OF THE INVENTION

### 1. Field of the Invention

The invention relates to a device and a method for masking fastening holes in rims using masking elements which can be for example balls or approximately conical plugs. The masking is usually carried out before the rims are lacquered or coated in another way. As a result, penetration of lacquer or other coating material into the fastening holes is prevented.

### 2. Description of the Prior Art

From the prior art, it is known to produce rims, as are provided for use on vehicles, from metal materials such as steel or aluminum. Such rims are provided with a coating which comprises one or more layers. The coating serves as corrosion protection for the metal material and often also for improving the aesthetic effect of the vehicle wheels. As coating methods for the vehicle wheels, wet lacquering methods and powder coating methods are customarily used, wherein these can also be combined with each other.

The rim has holes by means of which the rim can be fastened on an end-side flange of a vehicle axle. A first group of holes is formed by fastening holes, as such wheel bolt holes, which have contact surfaces for the heads of the wheel bolts. Furthermore, a rim as a rule has a central hole which serves for the centering of the rim with regard to the wheel axle and can accommodate a cover cap. The fastening holes—in contrast to the customary surface regions of the rim—are intended to be at least in the main free of coating after carrying out the coating of the rim. As a result, the effect of the pairing geometry between the wheel bolt and the rim in the region of the contact surface ensuring the necessary frictional engagement during operation is especially achieved. In the case of a coating remaining in the region of the contact surface the surface pressure between wheel bolt and rim can alter especially as a result of setting processes, which leads to the functional reliability being endangered.

From the prior art, it is known to mask the functional surfaces for the duration of the coating processes in order to prevent impingement and adherence of coating material there. To this end, before carrying out the coating by means of a handling device, which can be designed as a robot for example, masking elements such as balls or plugs are placed on the fastening holes and as a result these close these off. The robot is equipped with a multi-gripper as the tool, the gripping units of which are rigidly arranged corresponding to the fastening hole pattern of the rim. Such a multi-gripper can therefore only be used for one rim type. If rims of different types are to be masked in a coating plant then multi-grippers which are adapted to the rim types have to be made available to the robot, which is associated with high plant costs. Also, a change of rim types is only possible after a change of the multi-gripper in such coating plants. The tool change times which are required for this reduce the throughput of the coating plant.

A method for masking fastening holes of rims, in which a delta robot fits individual masking elements one after the other in the fastening holes, is known from the still unpublished German application DE 10 2015 013 117.6 of the applicant. As a result, the device, by reprogramming the movement paths, can be quickly adapted to different fastening hole patterns. However, this flexibility comes at the cost of speed since the holes are no long masked at the same time but in sequence.

### SUMMARY OF THE INVENTION

It is the object of the invention to specify a device for masking fastening holes in rims which is constructed in a particularly simple manner and can be inexpensively produced. It is also the object of the invention to specify a method by means of which fastening holes can be masked using masking elements in a particularly efficient manner.

With regard to the device, the object is achieved by means of a device which has a storage container for the masking elements and a pressure generating unit. The device also has a connection unit, which is connected to the storage container, and an at least basically tubular discharge device which is fastened on one end of the connection unit and has a discharge opening on the opposite end for discharging the masking elements. According to the invention, the discharge device has a tubular wall in which is formed a channel, connected to the pressure generating unit, for conducting a fluid which can be air or another gas or even a liquid, e.g. water or hydraulic oil. The tube wall consists at least partially of an elastic material through which extends the channel or in which is formed a cavity which is connected to the channel so that if the pressure of the fluid is altered the tube wall deforms and as a result reduces a clamping force which is exerted by a part of the tube wall upon one of the masking elements. If a plurality of such discharge devices are fastened on the connection unit, a plurality of masking elements can be discharged at the same time by reducing the respectively acting clamping force.

The device according to the invention is based on the consideration of deforming an elastic part of the tube wall of the discharge device with the aid of a pressurized fluid. The deformation, which can be either the consequence of a pressure increase or a pressure decrease, leads to the clamping force which is exerted upon a masking element being reduced. A force which has at least one component acting in the radial direction between the tube wall and the masking element and which can also result from the gravity force of the masking element is understood by a clamping force in this context. The clamping force for most of the time during operation of the device is at such a level that the masking element in the discharge device is retained against the action of its gravity force and therefore cannot discharge from the discharge opening. If the clamping force is reduced by a sufficient amount, then the gravity force of the masking element can overcome the clamping force, as a result of which the masking element moves forward in the discharge device. This pressure-initiated release of the masking element can be used either for the purpose of separating out a masking element from a group of a plurality of masking elements, or for discharging a single masking element from the discharge opening in order to mask the fastening hole of the rim. The same naturally also applies if the clamping force is returned completely to zero as a result of the pressure change.

On account of this functioning principle, at least the tube wall and preferably the entire connection unit and the discharge device can be designed in one piece and produced in a 3D-printing process. In the 3D-printing process, three-dimensional workpieces are built up in layers and in a computer-controlled manner from one or more fluid or solid materials. During the buildup, physical or chemical hardening or melting processes take place. For the present application, plastics or synthetic resins are particularly suitable as material for the 3D-printing since these frequently have the best elastic properties. The buildup of the individual layers can be carried out for example by way of fused deposition modeling (FDM). If different materials are combined, other criteria, e.g. abrasion resistance, can also be taken into consideration in addition to elasticity. Therefore, for example those regions of the discharge device which exert clamping forces upon the masking elements can consist of a non-slip and particularly abrasion-resistant material. For the surrounding regions, which are to be particularly easily deformable, an elastic material is frequently more favorable, however.

The adaptability to manufacture of the tube wall, of the discharge device with the tube wall or even of the overall complex consisting of connecting unit and discharge device in a 3D-printing process has the advantage that the device can be produced very inexpensively in this way. This in turn makes it possible to undertake an adaptation to a quite different fastening hole pattern by a new connection unit, with a plurality of discharge devices fastening thereon, being designed in a simple manner and produced by way of the 3D-printing. A complete new construction and installation of a multi-gripper, as was previously necessary in the prior art, is therefore replaced by very simple adaptations in the 3D-design and by an inexpensive 3D-printing which is associated therewith.

Particularly large reductions of the clamping force can be created if a cavity, which is connected to the channel and designed in the style of a one-sided bellows, is formed in the elastic material. The shape of the bellows is preferably adapted to the cross section of the discharge device, which can be circular but can also for example have the shape of an oval or a polygon.

In a one-sided bellows, the cavity usually has a plurality of fluidically interconnected sections which are arranged in series along an axial direction of the tube wall and have a larger and a smaller width alternately, wherein one side of the bellows has no recesses. With of a pressure change in such a cavity, forces which lead to deformation of the tube wall and as a result alter the clamping force are created with each change of the width of the cavity. As a result of the series-connection of a plurality of such sections with alternating widths the forces and the deflections of the tube wall which are achieved as a result can be increased.

The sections of the bellows can be in the form of a ring or ring segment especially when the cross section of the discharge device is circular.

If the sections with the smaller width have a larger inner radius, this means that the “folded” side of the bellows points inward and the recess-free side points outward. With a pressure increase, such a bellows bends outward and therefore increases the clear cross section of the tube wall, as a result of which masking elements can be separated out or discharged. Such an embodiment has the advantage that in the event of an undesirable pressure drop (perhaps on account of a malfunction of the pressure generating unit) no masking elements can leave the discharge device.

If, on the other hand, the pressure generating unit generates no positive pressure but a negative pressure, then the conditions are exactly the other way round. In this case, a bellows in which the “folded” side points outward is more favorable. With a corresponding design, such a bellows bends inward in the unpressurized state and is straightened by applying a negative pressure.

In one exemplary embodiment, a first channel and a second channel are formed in the tube wall for conducting a fluid and connected to the pressure generating unit so that the pressure of the fluid in the first channel and in the second channel can be altered independently of each other. The tube wall has a first section and a second section which is arranged in an axially offset manner to it in the direction of the discharge opening. The shape of the tube wall can be altered in the first section by altering the fluid pressure in the first channel and in the second section by altering the fluid pressure in the second channel so that masking elements which have accumulated in the discharge device can be separated out by the first section and discharged by the second section. By forming a plurality of channels, the masking elements can therefore be separated out and discharged in different sections of the tubular discharge device. As a result, the masking elements can be continuously fed from the storage container and by discharge at the discharge opening be individually deposited in the fastening holes of the rim.

In a particularly advantageous development, two or more discharge devices are fastened on the connection unit, each having a first channel and a second channel. The connection unit also has a first fluid connection and a second fluid connection. Formed in the connection unit is a first channel system which connects the first fluid connection to the first channels, and a second channel system which connects the section fluid connection to the second channels. In this way, a plurality of masking elements can be discharged at the same time and placed in the fastening holes of the rim. After discharging a set of masking elements, the masking elements which have accumulated in front of the first section of the discharge devices can be separated out in order to then be deposited on the fastening holes of the next rim in a further working cycle.

It is favorable in this case if the first channel system is formed in a first plane and the second channel system is formed in a second plane which is parallel to the first plane. A connection unit with channel systems which are spatially separated in this way can be produced in a particularly simple manner in a 3D-printing process.

In another exemplary embodiment, the tube wall has two oppositely disposed cavities and designed so that first masking elements are separated out or released only in the case of a simultaneous pressure change in relation to the ambient pressure in both cavities. Second masking elements, which have a smaller diameter than the first masking elements, are already separated out or released, however, in the case of a pressure change in relation to the ambient pressure in only one of the two cavities. Consequently, masking elements with different diameters can be used. As a result, rims with fastening holes of different sizes can also be equipped with masking elements which are adapted thereto.

In another exemplary embodiment, two or more discharge devices are fastened on the connection unit. The device has a deflection device which is designed for the purpose of deflecting the discharge devices and elastically deforming them in the process so that the position of the discharge openings of the discharge devices can be altered. In this case, the fact that the tube wall of the discharge devices partially consists of an elastic material anyway is exploited so that these can be deflected in the manner of a solid-body joint. In this way, it is possible to adapt the position of the discharge openings to different fastening hole patterns.

The deflection device can in this case be formed by an additional channel or an additional cavity in the tube wall of the respective discharge device. With a pressure change in relation to the ambient pressure in the additional channel or in the additional cavity, the tube wall is deformed so that the respective discharge device is deflected and the position of the discharge opening is altered. The deflection device is therefore integrated into the tube wall and can also be fluidically operated. As a result, the construction of the device becomes simpler and more reliable.

With regard to the method, the object referred to in the introduction is achieved by means of a method for masking fastening holes in rims using masking elements. The method according to the invention features the following steps:
a) providing the masking elements in a storage container;
b) feeding the masking elements to a connection unit which is connected to an at least basically tubular discharge device which has a discharge opening for discharging masking elements and a tube wall in which is formed a channel for conducting a fluid, wherein the tube wall consists at least partially of an elastic material through which the channel extends or in which is formed a cavity which is connected to the channel,
c) altering the pressure of the fluid in the channel in such a way that the tube wall deforms and as a result reduces the clamping force which is exerted by a part of the tube wall upon one of the masking elements.

The advantageous embodiments which are explained above with reference to the device according to the invention correspondingly apply to the method.

### BRIEF DESCRIPTION OF THE DRAWINGS

Exemplary embodiments of the invention are explained in more detail below with reference to the drawings. In these drawings:

FIG. 1 shows a front view of a masking device according to the invention according to a first exemplary embodiment;

FIG. 2 shows a longitudinal section through a plurality of discharge devices and a section of a connection unit of the masking device shown in FIG. 1;

FIG. 3a shows a horizontal section (of smaller scale) through the detail shown in FIG. 2 along the line IIIa-IIIa;

FIG. 3b shows a horizontal section (of smaller scale) through the detail shown in FIG. 2 along the line IIIb-IIIb;

FIG. 4a shows an enlarged detail from FIG. 2, wherein a bellows used for the discharging is unpressurized;

FIG. 4b shows the detail shown in FIG. 4a but after pressurizing of the bellows;

FIG. 5a shows a detail based on the view of FIGS. 4a and 4b according to a second exemplary embodiment in which the recesses of the bellows point inward in the unpressurized state;

FIG. 5b shows the detail shown in FIG. 5a but after pressurizing;

FIG. 6a shows a detail of a discharge device based on the view of FIGS. 4a and 4b according to a third exemplary embodiment in the unpressurized state;

FIG. 6b shows the detail shown in FIG. 6a after pressurizing;

FIG. 7a shows the detail shown in FIG. 6a, wherein balls with different diameters are indicated;

FIG. 7b shows the detail shown in FIG. 7a, wherein only one channel is pressurized with compressed air;

FIG. 8a shows an arrangement of a plurality of discharge devices according to a fourth exemplary embodiment in which for deflecting the discharge devices provision is made for a central cam disk, in a side view (at the top) and in a bottom view (at the bottom);

FIG. 8b shows two views corresponding to FIG. 8a after rotation of the cam disk;

FIG. 9a shows an arrangement of a plurality of discharge devices according to a variant of the fourth exemplary embodiment in which for deflecting the discharge devices provision is made for a central cone disk, in a side view (at the top) and in a bottom view (at the bottom);

FIG. 9b shows two views corresponding to FIG. 9a after axial displacement of the cone disk;

FIG. 10 shows a side view of a masking device according to the invention according to a fifth exemplary embodiment in which the discharge devices are deflected with the aid of compressed air;

FIG. 11a shows a longitudinal section (at the top) and a horizontal section through a discharge device shown in FIG. 10 after application of pressurizing;

FIG. 11b shows two views corresponding to FIG. 11a in the unpressurized state of the discharge device;

FIG. 12 shows a horizontal section through the discharge device according to a first variant with only one first channel;

FIG. 13 shows a horizontal section through the discharge device according to a second variant with three first channels;

FIG. 14a shows a longitudinal section (at the top) and a horizontal section through the discharge device shown in FIG. 10 before a separating out;

FIG. 14b shows two views corresponding to FIG. 14a after a separating out;

FIG. 15 shows a horizontal section through the discharge device according to a third variant with first and second channels which are offset to each other;

FIG. 16a shows a longitudinal section (at the top) and a horizontal section through the discharge device shown in FIG. 10 before a deflection;

FIG. 16b shows two views corresponding to FIG. 16a after a deflection;

FIG. 17a shows an arrangement of a plurality of discharge devices according to the fifth exemplary embodiment before the deflection, in a side view (at the top) and in a bottom view (at the bottom);

FIG. 17b shows two views corresponding to FIG. 17a after the deflection.

### DESCRIPTION OF PREFERRED EXEMPLARY EMBODIMENTS

### 1. First Exemplary Embodiment

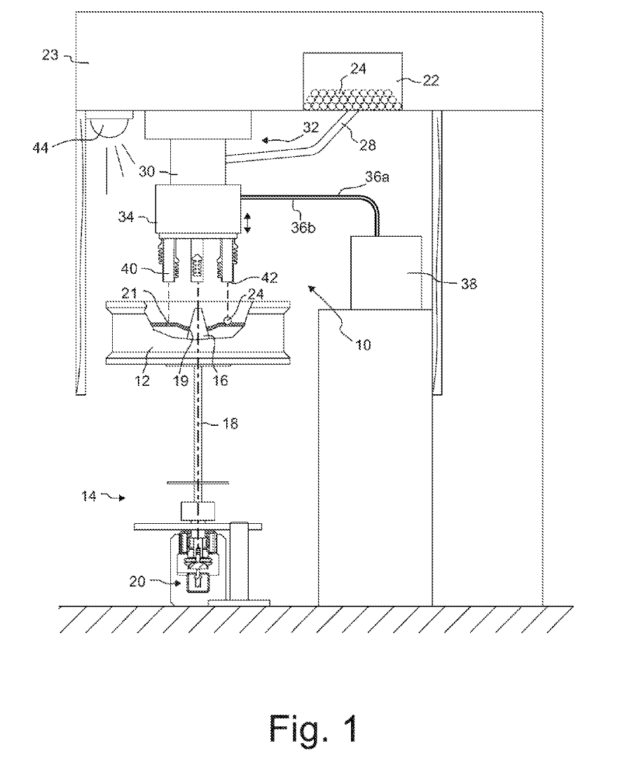

Shown in FIG. 1 is a masking device according to the invention in a front view and designated 10 as a whole.

The rims 12 which are to be coated in a subsequent treatment step are fed to the masking device 10 by a transporting device 14, the transporting device extending perpendicularly to the paper plane of FIG. 1. Each rim 12 is retained by a conical mandrel 16 which is fastened on one end of a rotatable spindle and engages in a central hub bore 19 of the rim 12. In addition to the central hub bore 19, each rim 12 has a plurality of fastening holes 21 which in the case of the depicted exemplary embodiment are distributed uniformly, i.e. at equal angular distances, around a pitch circle which is concentric to the symmetry axis of the rim 12. Naturally, other fastening hole patterns are also possible, as known per se in the prior art.

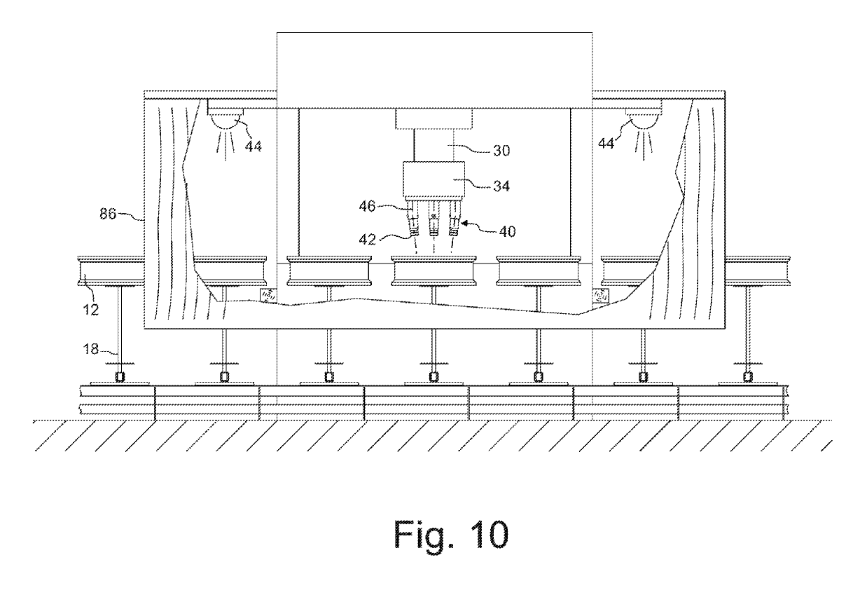

The opposite end of the spindle 18 is connected to a chain drive which conveys the spindle 18 and the rim 12, which is retained by the mandrel 16, along a transporting direction. A plurality of such spindles 18 which carry the rims 12 are arranged in series along the transporting direction 14, as can be seen further down in the side view of FIG. 10 in conjunction with another exemplary embodiment. By means of the chain drive 20, all the spindles 18 are therefore conveyed simultaneously and synchronously.

The masking device 10 comprises a storage container 22 which is located in a ceiling structure 23 and serves as a store for a multiplicity of balls 24 by means of which the fastening holes of the rim 12 can be masked. The storage container 22 is connected via a hose-like ball feed 28 to a distribution unit 30 in which the balls 24 are temporarily stored on a spiral track. The distribution unit 30 can be moved in the vertical direction with the aid of a lifting device 32, as is indicated in FIG. 1 by means of a double arrow.

Fastened on the bottom end of the distribution unit 30 is a connection unit 34 which is connected via hoses 36a, 36b to a pressure generating unit 38. The pressure generating unit 38 is able to adjust the air pressure in the hoses 36a, 36b independently of each other, specifically preferably between an outside operating normal pressure (approximately 1 bar) and an increased pressure, e.g. 2 bar. Alternatively to this, the pressure generating unit 38 can bring about a lowering of the pressure in the hoses 36a, 36b instead of an increase. Moreover, instead of air another gas or even a liquid cab can be fed to the hoses 36a, 36b as fluid.

Fastened on the bottom end of the connection unit 34 are four discharge devices 40, at the discharge openings 42 of which the balls 24 can be discharged in a compressed air-controlled manner. The discharge openings 42 are positioned in this case so that a discharge opening 42 is located over each fastening hole 21. Before discharge of the balls 24, the distribution unit 30 and the connection unit 34, with the discharge devices fastened thereto, are lowered with the aid of the lifting device to the extent that the discharge openings 42 are located directly over the fastening holes 21. By way of illustration, a ball 24 is shown in its final position in one of the fastening holes 21; in actual operation, all four fastening holes are always masked by balls 24 at the same time.

Fastened on the ceiling structure 23 is a camera 44 which monitors the discharge process so that a central control unit can engage in a correcting manner if necessary. It has to be ensured in particular that the rim 12 is located both in the correct rotational orientation and at the correct location along the transporting direction which is perpendicular to the paper plane. Only then can the balls 24 be reliably deposited in the fastening holes 21 of the rim 12.

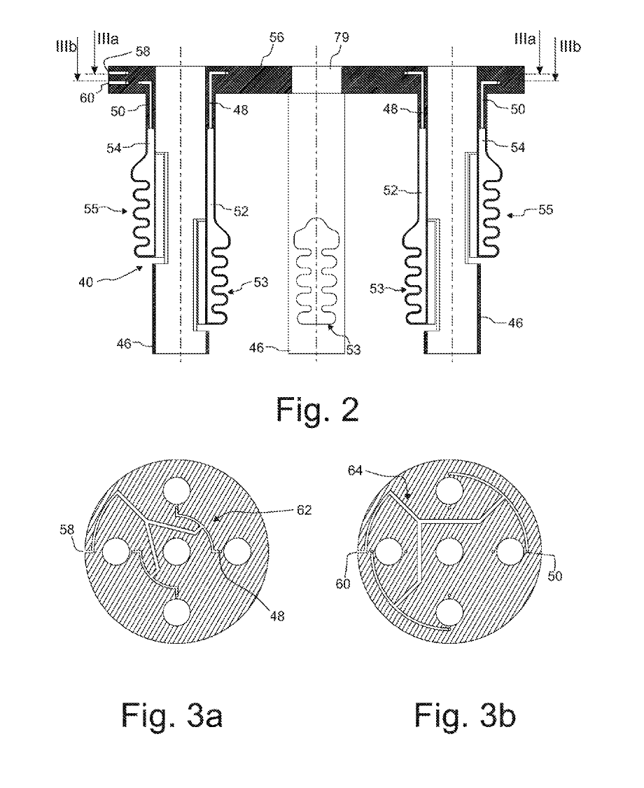

FIG. 2 shows an enlarged detail from FIG. 1, in which the discharge devices 40 can be seen better. In the depicted exemplary embodiment, the discharge devices 40 are designed in one piece with the connection unit 34 and produced in a 3D-printing process. The material used is elastic to the extent that the tubular discharge devices 40, with sufficiently thin wall thicknesses, can change their shape by compressed air operation, which is explained in more detail below.

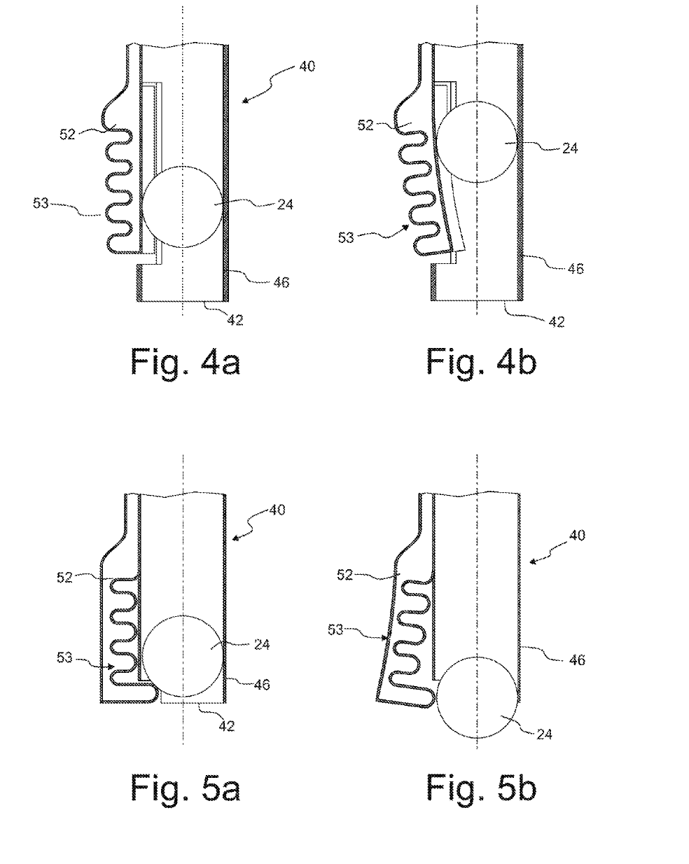

The discharge devices 40 consist in the main of a tube wall 46, the external contour of which has the basic shape of a circular cylinder. Formed in each tube wall 46 is a first channel 48 and a second channel 50 which extend in the axial direction from the top downward through the tube wall 48. The channels 48, 50 terminate in each case in a first cavity 52 or in a second cavity 54 which are located in sections of the discharge devices 40 which are axially offset to each other. The cavities 52, 54 have in each case the form of a one-sided bellows 53 or 55 and are explained in detail further down with reference to FIGS. 4a and 4b.

In a bottom section of the connection unit 34, designated 56, the first channels 48 and the second channels 50 of all four discharge devices 40 are connected to a common first fluid connection 58 or to a common second fluid connection 60.

FIGS. 3a and 3b show the bottom section 56 of the connection unit 34 in two different horizontal cross sections along the lines IIIa and IIIb. In the cross sections (shown here in reduced size), it can be seen that the fluid connections 58, 60 are connected to all the first channels 48 or to all the second channels 50 of the four discharge devices 40 via branched channel systems 62 or 64 which are located in different horizontal planes which are parallel to each other. The channel systems 62 or 64 are designed in this case so that the channels are of equal lengths between the fluid connections 58 or 60 on one side and the cavities 52, 54 on the other side in each case. In this way, it is ensured that pressure changes propagate in all the channels in the same way.

The function of the channels 48, 50 and of the cavities 52, 54 which are fluidically connected thereto is explained below with reference to FIGS. 4a and 4b. Shown enlarged in FIG. 4a is the first bellows 53 of the discharge device 40 which is shown on the right in FIG. 2. The first bellows 53 constitutes a part of the tube wall 46 and encloses the end of the first cavity 52. The first cavity 52 has a plurality of fluidically interconnected sections which are arranged in series along an axial direction of the tube wall 46 and have a larger and a smaller width alternately. Each individual section—and therefore also the entire first bellows 53—is approximately in the form of a ring segment, wherein the sections with the smaller width have the smaller outer radius. As a result, the “folded” side of the first bellows 53 points outward and its recess-free side points inward. On the outside of the bellows 53, the tube wall 46 has incisions so that the bellows 53 can deform without hindrance in the radial direction in the way described below.

If the pressure generating unit 38 is actuated so that via the hose 36a the air pressure at the first fluid connection 58 is increased, then the increased pressure is distributed via the first channel system 62 to the first channels 48 in all the discharge devices 40. The pressure increase in the second cavity 54 produces the effect of the first bellows 53 bending inward, as is shown in FIG. 4b. This is associated with the fact that increased pressure forces apart the wide sections of the first bellows 53. As a result of the asymmetrical design of the bellows 53, a deformation of the tube wall 46 occurs in the region of the bellows 53 which in its turn leads to a reduction of the inside diameter of the tube wall 46. As a consequence thereof, a ball 24 which is located in the discharge device 40 is clamped between the oppositely disposed parts of the tube wall 46.

In the unpressurized state shown in FIG. 4a, the first bellows hangs down slack, however, so that the ball 24 can fall downward out of the discharge opening 42 on account of its own weight.

In order to discharge the balls 24 with the aid of the discharge devices 40, the first bellows 53 therefore has to be pressurized with increased pressure in order to be able to initially retain the balls 24 in the discharge devices 40, as shown in FIG. 4b. As a result of lowering the air pressure in the first bellows 53, the clamping forces acting upon the balls 24 are reduced to the extent that the balls 24 can escape from the discharge openings 42.

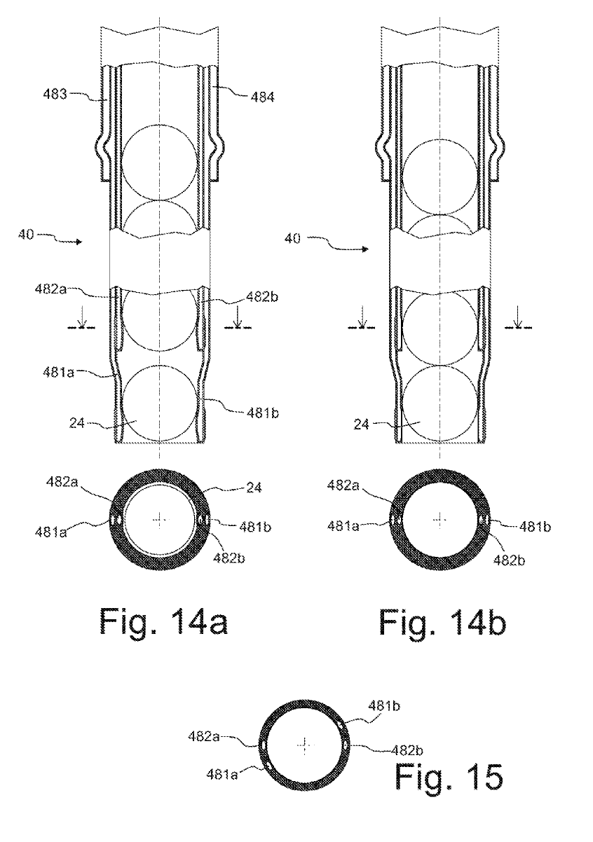

The second bellows 55 which are arranged above the first bellows 53 function in the same way. They have the object of separating out balls 24 which have accumulated in the discharge devices 40. In this way, it is ensured that during operation of the first bellows 53 not more than one ball 24 can ever escape from the discharge opening 42. In a corresponding manner, the second bellows 55 are pressurized in this case with compressed air from the pressure generating unit 38 via the second fluid connection 60. As a result of lowering the pressure, the clamping force is reduced so that a ball can pass through the second bellows 55. The process of the separating out is explained in more detail further down with reference to FIGS. 14a and 14b.

### 2. Second Exemplary Embodiment

In the exemplary embodiment shown in FIGS. 1 to 4, the clamping force acting upon the balls 24 is reduced if the pressure in the bellows 53, 55 is reduced. If on account of a malfunction of the pressure generating unit 38 or a split in the hoses 36a, 36b an undesirable pressure drop occurs in the bellows 53, 55, then the clamping force reduces. The discharge devices 40 then discharge all the balls 24 in rapid sequence, which of course is undesirable.

It is therefore more favorable if the discharge of a ball 24 does not require a pressure drop but an increased air pressure.

If only the (comparatively low) ambient pressure is applied to the bellows 53, 55, then the clamping forces which are then in effect should be of such strength that the balls 24 are not able to leave the discharge devices 40.

FIGS. 5a and 5b illustrate in views which are based on FIGS. 4a and 4b the bottom section of a discharge device 40 according to a second exemplary embodiment in which the one-sided first bellows 53 are oriented so that the “folded” side of the bellows points inward and the recess-free side points outward. In this configuration, the sections of the first cavity 52 with the smaller widths consequently have a larger inner radius.

Furthermore, an inwardly projecting protuberance 66 is located as the bottom end of the first bellows 53. In the unpressurized state shown in FIG. 5a, the protuberance 66 projects into the interior space of the discharge devices 40 by such distance that the ball 24 is retained by clamping forces between the protuberance 66 and the opposite inner wall of the tube wall 46.

If the air pressure in the first bellows 53 is increased, then this bends outward, as is shown in FIG. 5b. As a result, the protuberance 66 also migrates out of the interior space of the discharge device 40, as a result of which the path for the ball 24 is freed.

### 3. Third Exemplary Embodiment

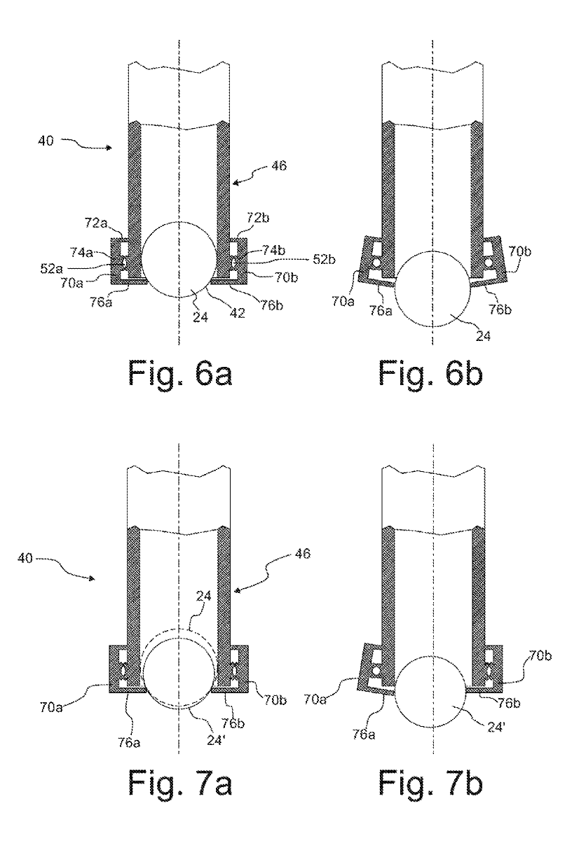

FIGS. 6a, 6b, 7a and 7b show the end section of a discharge device 40 according to a third exemplary embodiment. In this case, the tube wall 46 has two oppositely disposed yokes 70a, 70b toward the discharge opening 42 which in each case are connected to an inner section of the tube wall 46 via a narrow first side 72a, 72b and via a wider second side 74a, 74b. Each yoke 70a, 70b has an inner flange-like projection 76a, 76b which in the unpressurized state shown in FIG. 6a reaches into the discharge opening 42 by such distance that a ball 24 which is located in the discharge device 40 is retained by the clamping forces.

Located in the second side 74a is a cavity 52a which is connected to the pressure generating unit 38 via a channel, which lies outside the sectional plane, and via the connection unit 34. A corresponding cavity 52b is located on the opposite side in the second side 74b. The two cavities 52a, 52b can be pressurized with compressed air independently of each other.

If both cavities 52a, 52b are filled with compressed air, then the cavities expand and deflect the yokes 70a, 70b so that the flange-like projections 76a, 76b move away and free the path for the ball 24, as is shown in FIG. 6b.

If only one of the cavities 52a or 52b is pressurized with compressed air, the respectively other yoke 70b or 70a remains in its original position, as is shown in FIG. 7b. The cross section inside the discharge device 40 is then tapered so that smaller balls 24′ can certainly pass through the discharge opening 42, as is shown in FIG. 7b. Larger balls 24, however, remain clamped in this position between the flange-like projections 76a, 76b. Therefore, the discharge devices 40 according to this exemplary embodiment are suitable for the purpose of discharging balls 24, 24′ of different sizes in a controlled manner. Naturally, this mechanism can also be used for the purpose of separating out accumulated balls.

### 4. Fourth Exemplary Embodiment

In the previously described exemplary embodiments, it was implied that the position of the discharge openings 42 cannot be altered. For different fastening hole patterns of the rims 12 at least the connection unit 34, with the discharge devices 40 fastened thereon, therefore has to be exchanged.

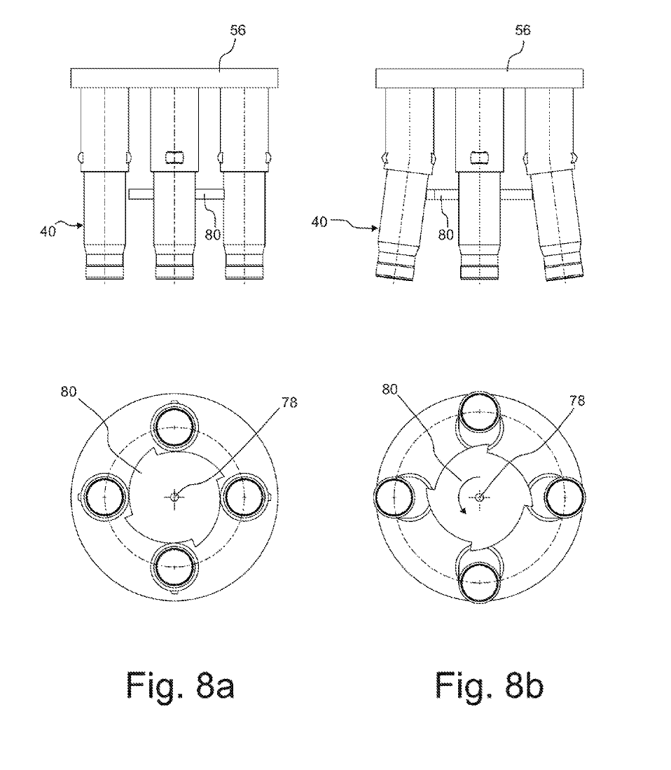

FIGS. 8a and 8b shown in a side view (at the top) and in a bottom view (at the bottom) an exemplary embodiment in which the masking device 10 has a deflection device by means of which the elastic discharge devices 40 can be deflected in the radial direction. For this purpose, the deflection device has a central shaft 78 which extends parallel to the discharge devices 40 and concentrically to the symmetry axis of the rim 12. The shaft 78 can in this case extend through a central opening 79 in the connection unit 34, as can be seen in FIG. 2.

Fastened on the bottom end of the shaft 79 is a cam disk 80 which can be seen best in the bottom view of FIGS. 8a, 8b. If the cam disk 80 is rotated anticlockwise with the aid of the shaft 78, as is indicated in FIG. 8b by means of an arrow, then the cam disk 80 spreads apart the discharge devices 40 which butt against its periphery so that their discharge openings 42 move outward. As can be seen in FIG. 8b, the discharge devices 40 no longer extend parallel to each other in this spread apart state but are deflected radially outward in each case. In this way, a rim 12 can be fitted with balls 24 using the same masking device 10, wherein the fastening holes 21 are arranged on a pitch circle with a larger radius.

The shaft 79 with the cam disk 80 can in principle also be produced by means of a 3D-printing process. It is also possible to produce the shaft 79 and the cam disk 80 from conventional metal materials.

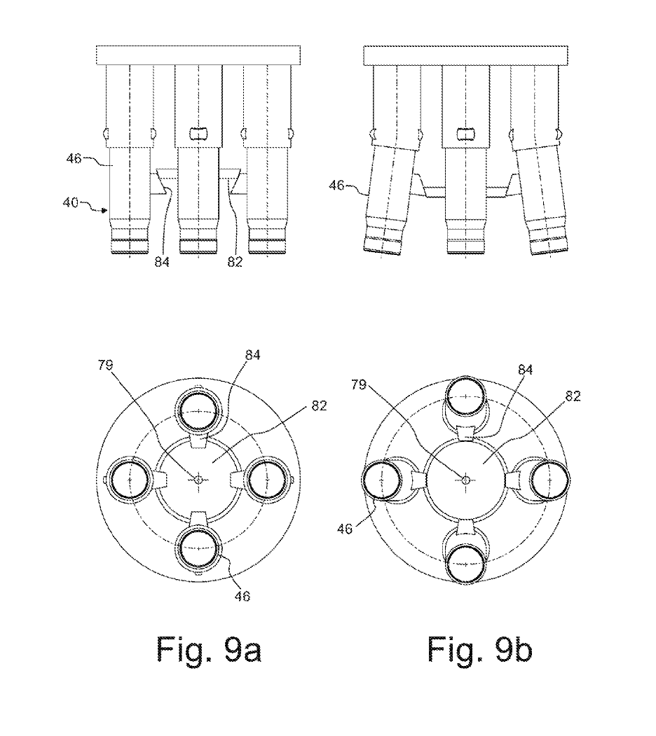

FIGS. 9a and 9b show in a view based on FIGS. 8a and 8b a variant of this concept. There is no cam disk fastened on the shaft 79 in this case but a cone disk 82, the circumferential surface of which is conical. Formed on the tube wall 46 of each discharge device 40 is a radially inwardly projecting and obliquely extending contact surface 84 which interacts with the cone disk 82. If the cone disk 82 is displaced downward by lowering the shaft 79, then the disk 82 presses the corresponding contact surfaces 84 outward. As a result, the discharge devices 40 are deflected radially outward at the same time in the same way, as is the case in the variant shown in FIGS. 8a and 8b. The essential difference between the two variants lies in the fact that the operation is not carried out via a rotation but via an axial displacement of the shaft 79.

### 5. Fifth Exemplary Embodiment

FIG. 10 shows a masking device according to the invention according to a fifth exemplary embodiment in a side view. Parts of a protective wall 86 facing the viewer are not shown in order to free the view of the connection unit 34 and the discharge devices 40.

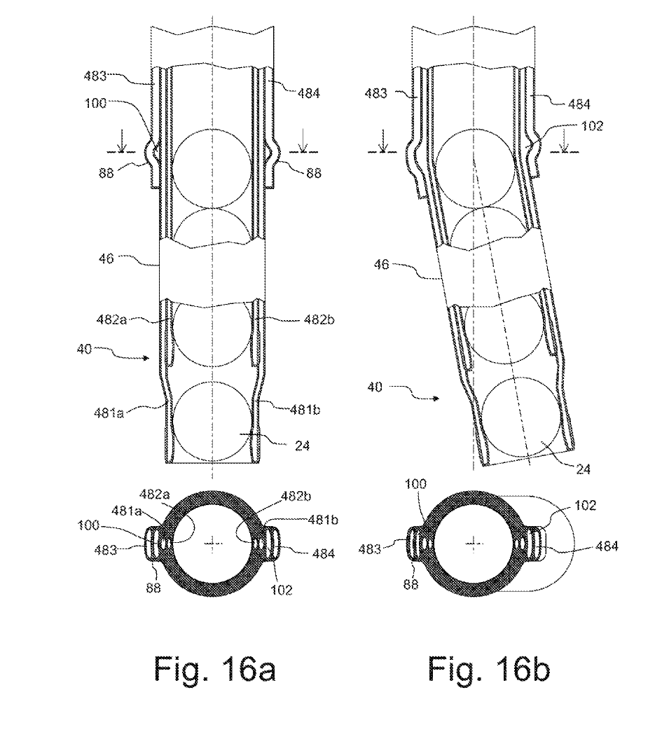

It can be seen in FIG. 10 that the discharge devices 40 are located in an angled position although there is no cam disk 80 or cone disk 82 located in the middle between the discharge devices 40, as in the exemplary embodiment shown in FIGS. 8 and 9. The deflection of the discharge devices 40 is also achieved pneumatically in this exemplary embodiment by channels and cavities in the elastic tube wall 46, as is explained in more detail further down with reference to FIGS. 16a, 16b and also 17a and 17b.

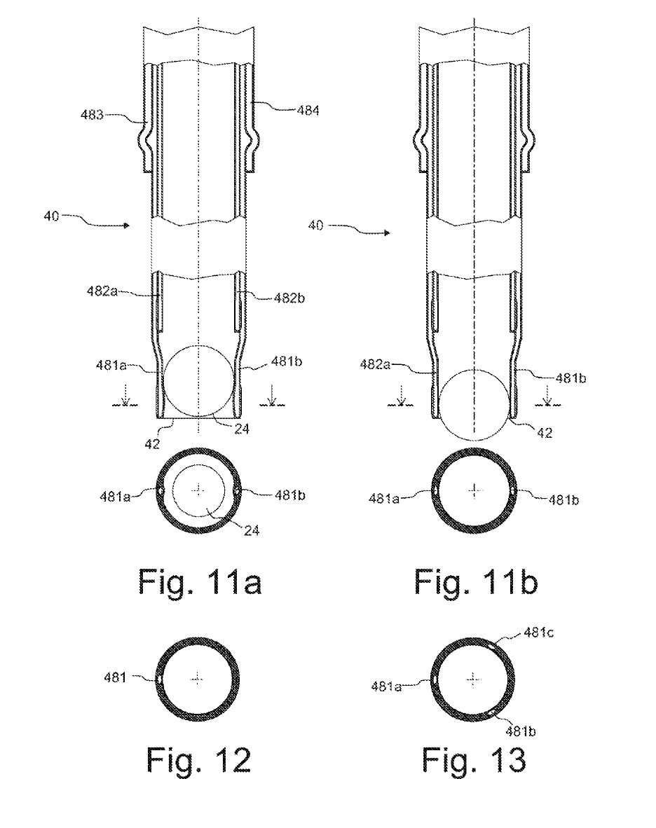

FIG. 11a shows at the top a longitudinal section through one of the discharge devices 40 shown in FIG. 10, and at the bottom shows a cross section through this discharge device 40 at a level shortly before the discharge opening 42. The tube wall also consists of an elastic material in this exemplary embodiment, in which tube wall are formed altogether six channels with different axial extents, which can be seen best in the cross section of FIG. 16a.

A first pair of channels 481a, 481b can be pressurized with compressed air only together and extend from the connection unit 34 downward as far as the discharge opening 42. As can be seen in FIG. 11a at the bottom, the first channels 481a, 481b have an oval cross section which does not alter substantially over the entire axial extent of the channel and widens out slightly only in the region of an end-side section. If the pressure generating unit 38 forces compressed air into the first channels 481a, 481b, these expand particularly in the widened out end-side section, as a result of which the clear inner cross section of the discharge device 40 is reduced. The clamping forces which are exerted on a ball 24 which is located in the proximity of the discharge opening 42 produces the effect of the ball not being able to leave the discharge device 44.

If the air pressure in the first channels 481a, 481b is reduced, then the tube wall 48 deforms in a way which leads to an increase of the inside diameter. The clamping forces acting upon the balls 24 disappear as a result, or become so small that the ball 24 can overcome these clamping forces on account of their own weight and fall out of the discharge opening 42, as in shown in FIG. 11b.

Instead of providing two oppositely disposed first channels 481a, 481b, the controlled discharge of the ball 24 can also be effected by means of only a single channel 481, as is the case in the variant shown in FIG. 12. Naturally, more than two channels are also possible; FIG. 13 shows a variant in which three first channels 481a, 481b and 481c are distributed uniformly over the periphery of the tube wall 48.

With reference to FIGS. 14a and 14b it is explained below how balls 24 accumulated in the discharge device 40 can be separated out before they are discharged in the previously described manner.

For this purpose, the air pressure is altered in the second channels 482a, 482b, which—unlike the first channels 481a, 481b—do not extend as far as the discharge opening but terminate approximately by a ball diameter above the discharge opening 42, as can be seen in the longitudinal section of FIG. 14a. The second channels 481a, 481b also have an oval cross section which does not alter substantially over the entire axial extent of the channel and slightly widen out only toward the end. If the second channels 482a, 482b are pressurized with compressed air by the pressure generating unit 38, they expand particularly at their end-side section, as can be seen in FIG. 14a. As a consequence thereof, the shape of the tube wall 46 alters so that approximately radially acting clamping forces are exerted upon the ball 24 which is located in the proximity of the end-side section, as a result of which this is blocked in the axial direction.

In order to separate out a ball from a plurality of accumulated balls 24, the air pressure in the second channels 482a, 482b is reduced, as is shown in FIG. 14b. The inner cross section of the tube wall 48 increases as a result of this in the region of the end-side section of the channels 482a, 482b, as result of which the previously clamped ball 24 can pass through this section of the discharge device 40. If the air pressure is increased again shortly after this, the falling next ball 24 is blocked again. As a result of coordinated pressurizing of the first channels 481a, 481b and the second channels 482a, 482b, the balls 24 can therefore be individually separated out and discharged from the discharge opening 42.

FIG. 15 shows a cross section through a tube wall 46, in which the pair of first channels 481a, 481b are arranged in an angularly offset manner to the pair of second channels 482a, 482b.

The deflection of the discharge devices 40 is explained below with reference to FIGS. 16a and 16b. The tube wall 46, in an upper section of the discharge device 40, has two outer ribs 88 diametrically opposite each other, in which extend a third channel 483 and a fourth channel 484 which can be pressurized with compressed air independently of each other. At the level of the sectional plane the two channels 483, 484 are guided around a cavity 100 or 102 which is not connected to a channel. This bent channel guiding leads to the two channels 483, 483 exerting tensile forces upon the subjacent sections of the tube wall 46 beneath the cavities 100, 102.

If both channels 483, 484 are pressurized with compressed air, then the discharge device 40 remains oriented in a straight line as a consequence of the symmetrical tensile forces. If the air pressure in the third channel 483 is reduced, then the forces which are created by the channels 483, 484 no longer increase. The tensile forces in the fourth channel 484 lead to the sections beneath the third and fourth channels 483, 484 to be deflected sideways, as is illustrated in FIG. 16b.

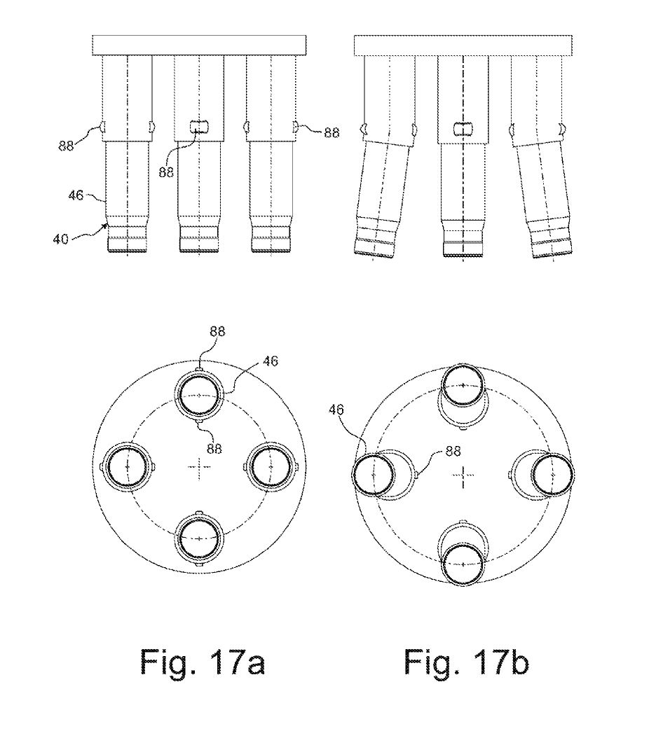

FIGS. 17a and 17b illustrate the deflection of all four discharge devices 40 of the exemplary embodiment shown in FIG. 10. The outer ribs 88, with the third and fourth channels 483, 484 extending therein, are arranged in a distributed manner over the peripheries of the discharge devices 40 so that the discharge openings 42 move in the radial direction if the pressure ratios in the channels 483, 484 alter. In this way, it is possible to adapt the position of the discharge openings 42 to different pitch circle diameters of the fastening holes without the discharge openings 42 having to be deflected from a central deflection direction which pushes the discharge devices 40 outward.

If the discharge devices 40 are to be deflected in chosen directions, at least one additional fifth channel is to be provided in addition to the third channel 483 and the fourth channel 484. These three channels are then distributed over the periphery of the tube wall 46 preferably with a 120° angular spacing. As a result, the masking device can be adapted in a more flexible manner to different fastening hole patterns and to positional changes of the rim 12. If the rim 12 is for example not located in the desired angular orientation, then the discharge devices 40 can all be deflected tangentially in the same rotational direction. Alternatively or in addition to this, it is possible to rotate the spindle 18 by means of an operating device, which for example can be integrated into the lifting device 32 and is not shown in the figures, and/or to rotate the entire connection unit 34 with the discharge devices 40 fastened thereon.

### 6. List of Designations

10 Masking device
12 Rim
14 Transporting device
16 Mandrel
18 Spindle
19 Hub bore
20 Chain drive
21 Fastening hole
22 Storage container
23 Ceiling structure
24 Ball
28 Ball feed
30 Distribution unit
32 Lifting device
34 Connection unit
36a Hose
36b Hose
38 Pressure generating unit
40 Discharge device
42 Discharge opening
44 Camera
46 Tube wall
48 First channel
50 Second channel
52 First cavity
53 First bellows
54 Second cavity
55 Second bellows
56 Bottom section
58 First fluid connection
60 Second fluid connection
62 First channel system
64 Second channel system
66 Protuberance
70 Yoke
72 First side
74 Second side
76 Flange-like projection
78 Shaft
80 Cam disk
82 Cone disk
84 Contact surface
86 Protective wall
88 Outer rib
100 Cavity
102 Cavity
481 First channel
482 Second channel
483 Third channel
484 Fourth channel

What is claimed is:

1. A device for masking fastening holes in rims using masking elements, comprising:
a storage container for masking elements;
a pressure generating unit;
a connection unit which is connected to the storage container; and
an at least basically tubular discharge device which is fastened on one end of the connection unit and on an opposite end has a discharge opening for discharging the masking elements,
wherein
the discharge device has a tube wall in which is formed a channel which is connected to the pressure generating unit, for conducting a fluid, and in that
the tube wall consists at least partially of an elastic material through which extends the channel or in which is formed a cavity which is connected to the channel, so that if the pressure of the fluid is altered the tube wall deforms and as a result a clamping force, which is exerted by a part of the tube wall upon one of the masking elements, is reduced.

2. The device as claimed in claim 1, wherein at least the tube wall is designed in one piece and produced in a 3D-printing process.

3. The device as claimed in claim 2, wherein at least the connection unit and the discharge device tube wall are designed in one piece and produced in a 3D-printing process.

4. The device as claimed in claim 1, wherein a cavity, which is connected to the channel and designed in a style of a one-sided bellows, is formed in the elastic material.

5. The device as claimed in claim 4, wherein the cavity has a plurality of fluidically interconnected sections which are arranged in series along an axial direction of the tube wall and have a larger and a wider width alternately.

6. The device as claimed in claim 5, wherein the plurality of fluidically interconnected sections are in the form of a ring or ring segment.

7. The device as claimed in claim 5, wherein the plurality of fluidically interconnected sections with a smaller width have a larger inner radius.

8. The device as claimed in claim 1, wherein
a first channel and a second channel for conducting a fluid are formed in the tube wall and connected to the pressure generating unit so that a pressure of the fluid in the first channel and a pressure of the fluid in the second channel can be altered independently of each other, and in that
the tube wall has a first section and a second section which is arranged in an axially offset manner thereto in a direction of the discharge opening, wherein in the first section a shape of the tube wall can be altered by altering the fluid pressure of fluid in the first channel and in the second section a shape of the tube wall can be altered by altering the fluid pressure of fluid in the second channel so that masking elements accumulated in the discharge device can be separated out by the first section and discharged by the second section.

9. The device as claimed in claim 8, wherein
two or more discharge devices each having a first channel and a second channel and being fastened on the connection unit,
the connection unit has a first fluid connection and a second fluid connection,
a first channel system, which connects the first fluid connection to the first channels of the two or more discharge devices, is formed in the connection unit, and in that
a second channel system, which connects the second fluid connection to the second channels of the two or more discharge devices, is formed in the connection unit.

10. The device as claimed in claim 9, wherein the first channel system is formed in a first plane and the second channel system is formed in a second plane which is parallel to the first plane.

11. The device as claimed in claim 1, wherein the tube wall has two oppositely disposed cavities which are designed so that first masking elements are separated out or released only in the case of a simultaneous pressure change in relation to the ambient pressure in both cavities, and in that second masking elements, which have a smaller diameter than the first masking elements, are separated out or released in the case of a pressure change in relation to the ambient pressure in only one of the two cavities.

12. The device as claimed in claim 1, wherein two or more discharge devices are fastened on the connection unit, and in that the device has a deflection device which is designed for the purpose of deflecting the discharge devices and elastically deforming them in the process so that the position of the discharge openings of the discharge devices is altered.

13. The device as claimed in claim 12, wherein the deflection device is formed by an additional channel or an additional cavity in the tube wall of the respective discharge device, and in that in the case of a pressure change in relation to the ambient pressure in the additional channel or in the additional cavity the tube wall deforms so that the respective discharge device is deflected and the position of the discharge opening is altered.

14. A method for masking fastening holes in rims using masking elements, wherein the method comprises the following steps:
a) providing the masking elements in a storage container;
b) feeding the masking elements to a connection unit which is connected to an at least basically tubular discharge device which has a discharge opening for discharging the masking elements and tube wall in which is formed a channel for conducting a fluid, wherein the tube wall consists at least partially of an elastic material through which extends the channel or in which is formed a cavity which is connected to the channel.
c) altering the pressure of the fluid in the channel in such a way that the tube wall deforms and as a result a clamping force, which is exerted by a part of the tube wall upon one of the masking elements is reduced.

15. (canceled)
